(19) United States
(12) Patent Application Publication
(10) Pub. No.: US 2013/0024614 A1
(43) Pub. Date: Jan. 24, 2013

(54) STORAGE MANAGER

(71) Applicants: Balaji Natrajan, Spring, TX (US); Michael G Myrah, Cypress, TX (US); Pruthviraj Herur Puttaiah, Tomball, TX (US)

(72) Inventors: Balaji Natrajan, Spring, TX (US); Michael G Myrah, Cypress, TX (US); Pruthviraj Herur Puttaiah, Tomball, TX (US)

(21) Appl. No.: 13/186,527

(22) Filed: Jul. 20, 2011

(51) Int. Cl. G06F 12/08

(52) U.S. Cl. 711/114; 711/E12.019

(57) ABSTRACT

A switch includes an expander to couple an array controller to storage drive bays which are capable of supporting physical drives. A zone manager is coupled to the expander to perform zoning configuration of physical drives for the array controller. A storage manager is used to generate storage configuration information used by the array controller to configure logical drives of the physical drives configured for the array controller.

### BACKGROUND

Direct-attached storage (DAS) refers to a data storage system that is directly attached to a server or workstation. The data capacity and connectivity of the DAS system may be improved through the use of switches or expanders, which enable a large bank of DAS devices to be coupled to multiple servers. A common communications protocol for enabling communications between the servers and the storage drives is the serial attached small computer system interface (SAS). SAS devices such as storage controllers, storage drives, and expanders communicate with each other using the SAS protocol. The interconnection network between the SAS devices may be referred to as a fabric. The storage resources of the DAS devices are made accessible to servers by configuring zone groups, which control how the expanders route connections through the switch to couple specific servers to specific storage drive bays. Zoning operations and SAS fabric device discovery can be performed by a zone manager entity that resides on the SAS switch.

### BRIEF DESCRIPTION OF THE DRAWINGS

Certain exemplary embodiments are described in the following detailed description and in reference to the drawings, in which:

FIG. 1 is a block diagram of a DAS system in accordance with embodiments;

FIG. 2 is a process flow diagram of a method of operating a storage manager in accordance with embodiments; and

FIG. 3 is a block diagram showing a non-transitory, computer-readable medium that stores instructions for operating a storage manager in accordance with embodiments.

### DETAILED DESCRIPTION OF SPECIFIC EMBODIMENTS

Disclosed are embodiments of techniques for storage management in a direct attached storage (DAS) system. More specifically, embodiments of the present techniques provide for configuration of physical drives and logical drives for an array controller. In one embodiment, disclosed is a switch that includes an expander, zone manager and storage manager. The expander is to couple an array controller to storage drive bays which are capable of supporting physical drives. The zone manager is coupled to the expander to perform zoning configuration of physical drives for the array controller. The storage manager can generate storage configuration information to allow the array controller to configure logical drives of the physical drives configured for the array controller. In some embodiments, devices such as switches, array controllers, storage drives, and expanders can be serial attached small computer system interface (SAS) devices and can communicate with each other using the SAS protocol.

The present techniques may allow a switch to configure both physical drives and logical drives for an array controller. The switch is capable of configuring an array controller when it is both online and offline relative to the switch. These techniques may reduce the need for user to use a switch to configure physical drives for an array controller and then use a server associated with the array controller to configure logical drives for the array controller. For example, the present techniques may allow a user to use a switch to perform both physical drive and logical drive configurations. This may help reduce the amount of time a user would otherwise need to spend on logging into each server or host associated with array controller. Instead, the user would configure storage requirements of the array controller from a single switch. For example, a data center may have several servers which would require a user to access each of the servers to configure each of the array controllers associated with each server. Further, the present techniques may help reduce the need for a user to have to become familiar with two separate sets of configuration applications: one configuration application configured to execute on the server and another configuration application to execute on the switch. Instead, a user can employ a single configuration application for configuring the storage requirements of the array controller.

Further, the present techniques may reduce the need for a user to have to generate two separate sets of configuration instructions (scripts) for configuring storage requirements of the array controllers: one script for physical drive or zoning configuration at the switch and another script for logical drive configuration at the server. Instead, the present technique may allow a user to generate at the switch a single script to handle both storage configurations. Further, the present techniques allow for configuration of the array controllers at the switch which may reduce the need for performing storage configuration functions at servers which may be executing different operating systems.

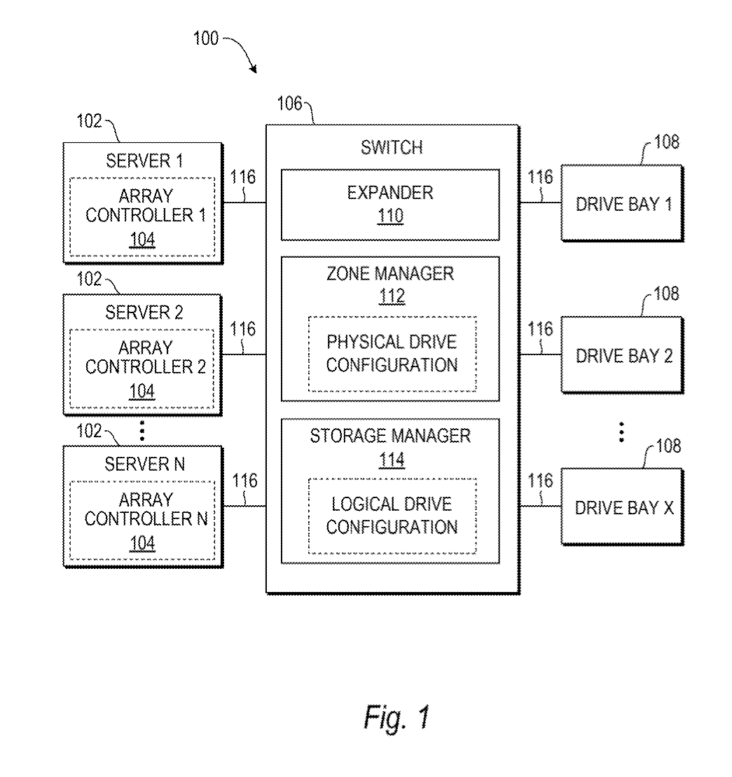

FIG. 1 is a block diagram of a DAS system in accordance with embodiments. The DAS system 100 may include servers 102 where each server is operatively coupled to one or more storage drive bays 108 which may or may not contain a storage drive, such as a disk drive, solid state drive, and the like. The servers 102 may include array controllers 104 to enable the servers to access and communicate with storage drives disposed in the storage drive bays 108. The array controllers 104 may be referred to as initiators, and each storage drive may be referred to as a target. The array controllers 104 can comprise storage controllers such as disk array controllers which can manage physical disk drives and can present them to the servers as logical units. In some examples, array controllers 104 can implement redundant array of independent disks (RAID) functionality and may be referred to as RAID controllers.

The servers 102, array controllers 104 and storage drive bays 108 may use the SAS protocol for connecting and transferring data. The DAS system 100 may also include a switch 106 for coupling servers 102 and array controllers 104 to storage drive bays 108. The switch 106 may use the SAS protocol for connecting and transferring data. In embodiments, servers 102, array controllers 104 and switch 106 may be installed in a blade enclosure. For example, the blade enclosure may include one or more blade bays for receiving blade servers 102, array controllers 104 and an interconnect bay for receiving switch 106. In embodiments, storage drive bays 108 may be included in a separate storage enclosure.

The switch 106 may include an expander 110 that controls the routing between servers 102 and the storage drive bays 108. The switch expander 110 may be coupled to one or more servers 102 and one or more storage drive bays 108 through physical interconnections 116, which may be cables or hardwired interconnections included in a storage or blade enclosure, for example. The two ends of a physical interconnection 116 are referred to herein as a port. The expander 110 may include a plurality of ports referred to herein as expander ports. Expander ports may be coupled to server ports and drive ports through the physical interconnections 116.

The switch 106 may also include a zone manager 112 for storage configuration of array controller 104 such as configuration of physical drives associated with drive bays 108. The zone manager 112 can configure expander 110 by defining zone groups and assigning zone groups to specified servers 102 and array controllers 104. As used herein, the term zone group refers to a set of one or more storage drive bays 108 that can be assigned to one or more initiators. Zone groups can be assigned to initiators through zone manager 112 according to a zoning configuration specified by the user. Commands may be sent from zone manager 112 to configure expander 110 such that a particular server 102 will be operatively coupled to one or more storage drive bays 108 specified by the user. In addition, commands may be sent from zone manager 112 to configure expander 110 such that a particular array controller 104 may be assigned particular physical drives associated with one or more storage drive bays 108 specified by the user. In this way, the user may control the connectivity between servers 102, array controllers 104 and storage drive bays 108. The zone manager 112 may also be operatively coupled to a storage administration device through a TCP/IP network connection, for example. The storage administration device may be, for example, a general purpose computer that enables an administrator to configure switch 106 remotely. The zone manager 112 may be operatively coupled to expander 110 using a communication interface such as an Ethernet interface, universal asynchronous receiver/transmitter (UART) serial connection, Inter-Integrated Circuit (I2C), or any other type or communication protocol.

The switch 106 also includes a storage manager 114 for storage configuration of array controller 104 including configuration of logical drives which have been assigned to array controller as physical drives associated with drive bays 108. The physical drives may have been assigned by zone manager 112. The storage manager 114 can facilitate configuration of array controllers 104 when the array controllers are both online and offline relative to switch 106. The array controller 104 is considered online relative to switch 106 when the array controller is powered on and in communication with the switch. On the other hand, array controller 104 is considered offline relative to switch 106 when the array controller is powered off and not in communication with the switch.

Like zone manager 112, storage manager 114 may be operatively coupled to a storage administration device through a TCP/IP network connection, for example. The storage administration device may be, for example, a general purpose computer that enables an administrator to configure switch 106 remotely. In some embodiments, the administration device can provide a user interface to allow a user to generate storage configuration information related to configuration of logical drives for array controller. For example, the user interface can include a command line interface (CLI), graphical user interface (GUI) or other means of providing information to storage manager 114. The storage configuration information can be generated using scripts or other forms of configuration instructions. The storage manager 114 may be able to communicate with servers 102 and array controllers using the SAS protocol. The storage manager 114 may be operatively coupled to expander 110 using a communication interface such as an Ethernet interface, UART serial connection, I2C, or any other type or communication protocol.

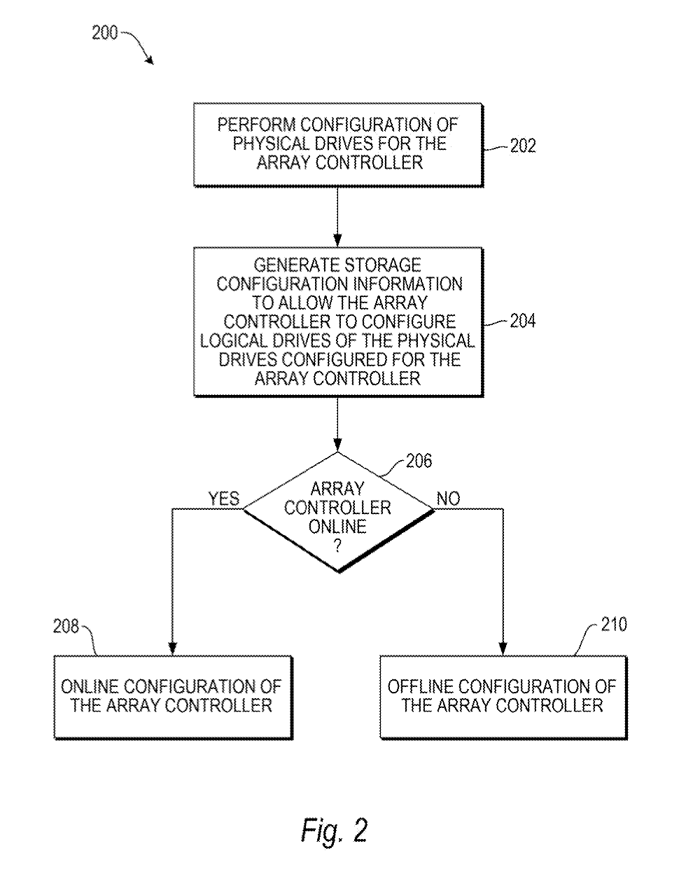

FIG. 2 is a process flow diagram of a method of operating storage manager 114 in accordance with embodiments. The method 200 may be performed by switch 106 shown in FIG. 1.

The method 200 may begin at block 202, wherein zone manager 112 performs zoning configuration of physical drives for array controller 104. In some embodiments, zone manager 112 can assign to array controller 104 a zone group. For example, zone manager 112 can communicate with expander 110 to assign to array controller 104 physical drives associated with drive bays 108.

At block 204, the storage manager 114 generates storage configuration information to allow array controller 104 to configure logical drives of the physical drives configured for the array controller. The storage configuration information can include logical drive information. For example, the logical drive information can include volume template information such as volume type, volume size, stripe, space and other pertinent information. The switch 106 can provide a user interface to allow a user to enter this information and be processed by storage manager 114. As explained below, storage manager 114 can use this information to facilitate configuration of array controller 104 when the array controller is online and offline relative to the switch.

At block 206, storage manager 114 determines whether array controller 104 is online or offline relative to the switch. If storage manager 114 determines that array controller 104 is online relative to switch, then processing proceeds to block 208. On the other hand, if storage manager 114 determines that array controller 104 is offline relative to switch, then processing proceeds to block 210.

At block 208, storage manager 114 can process the storage configuration information generated at block 204. This information can facilitate configuration of array controller 104 when the array controller is online relative to the switch. In one embodiment, switch 106 can perform discovery functions to determine information regarding availability of array controller 104. For example, switch 106 can obtain the array controller information when the switch is powered on using SAS discovery functionality such as using SAS DISCOVER commands. In another example, switch 106 can communicate to array controller 104 that storage configuration information is available using a BROADCAST command (primitive) or similar technique. Upon receiving this information, array controller 104 can retrieve the configuration information from switch 106 using a read command.

When switch 106 determines that array controller 104 is available, the switch can communicate with the array controller to determine whether it supports the same storage configuration protocol as the switch. For example, storage manager 114 can direct to array controller 104 a SCSI INQUIRY COMMAND to determine whether the array controller supports the same storage configuration protocol as the switch. The storage manager 114 can use this information to determine whether array controller 104 is capable of having storage manager 114 provide the storage configuration information to allow the array controller to configure logical drives of the physical drives configured for the array controller.

The storage manager 114 can then direct to array controller 104 a command containing the storage configuration information to allow the array controller to configure logical drives of the physical drives configured for the array controller. For example, storage manager 114 may direct to array controller 104 a lock command to obtain exclusive control of the array controller to allow it to configure logical drives using the storage configuration information from storage manager 114. The storage manager 114 may then communicate to array controller 104 a command with the storage configuration information to allow the array controller to configure logical drives of the physical drives configured for the array controller. As explained above, storage configuration information can include logical drive information. For example, the logical drive information can include volume template information such as volume type, volume size, stripe, space and other pertinent information. The array controller 104 can use the storage configuration information to configure logical drives of the physical drives configured for the array controller. In this manner, array controller 104 can process this information as if it were being provided by server 102 even though it is being provided by switch 106. In some embodiments, as explained above, storage manager 114 can provide a user interface to allow a user to generate the configuration information. The storage configuration information can be generated using scripts or other human readable form of configuration instructions.

At block 210, storage manager 114 can process the storage configuration information generated at block 204 to facilitate configuration of array controller 104 when the array controller is offline relative to switch 106. As explained above, the storage configuration information can include logical drive information. For example, the logical drive information can include volume template information such as volume type, volume size, stripe, space and other pertinent information. The storage configuration information can be stored on switch 106 for later retrieval by array controller 104 when the status of array controller changes from offline to online. For example, the storage configuration information can be stored in persistent memory on switch 106 which can be later accessed by array controller 104 through SAS serial management protocol (SMP) commands based on the device bay location of array controller 104. In some embodiments, serial SCSI protocol (SSP) commands could be used to perform this operation.

When the status of array controller 104 changes from offline to online (e.g., powered on), the array controller can detect the presence of SAS devices such as switch 106. For example, array controller 104 can discover switch 106 using SAS DISCOVER commands. This command may allow array controller 104 to communicate with switch 106 to obtain storage related information such as physical drives assigned to the array controller and storage configuration information for logical drive configuration.

In one embodiment, array controller 104 can be configured to control its power up process when coupled to switch 106. For example, array controller 104 can be configured to pause or suspend its power on self test (POST) function until it has processed the storage configuration information from switch 106. This may allow array controller 104 to communicate with switch 106 and to perform its discovery process including discovery of the switch. The array controller 104 can direct SAS commands to switch 106 to communicate with the switch regarding storage configuration information stored at the switch. For example, array controller 104 can generate an SMP READ VOLUME TEMPLATE command to determine if switch 106 contains any storage configuration information. The SMP READ VOLUME TEMPLATE command may include information about array controller 104 such as drive bay location of the array controller to allow expander 110 to return the appropriate storage configuration information for the particular array controller.

If there is storage configuration information present at switch 106, array controller 104 can process the information for configuration of logical drives at the array controller. For example, the storage configuration information may include instructions on how to create volumes from the physical drives assigned to the array controller. Once array controller 104 processes the storage configuration information, the array controller can communicate status information back to switch 106. For example, array controller 104 can generate a SMP WRITE VOLUME TEMPLATE STATUS command directed to switch 106 or expander 110. This status command may include status information such as the status of the command executed by array controller 104 as well as the initiator SAS address that executed the command. This status command may also include the blade bay location of array controller 104 to allow expander 110 to determine which array controller sent the status command. The switch 106 may collect from array controller 104 this information which it can use to communicate to a user the status of the storage configuration commands.

As explained above, in one embodiment array controller 104 can be configured to control its power up process such as by pausing or suspending its POST until it has processed the storage configuration information. In one embodiment, once array controller 104 has completed execution of the storage configuration information, the array controller can resume its POST process and proceed to execute the operating system (OS) on the array controller. In another embodiment, switch 106 can be configured to reset array controller 104. For example, in a blade system configuration, switch 106 can generate a simple object access protocol (SOAP) command directed to an onboard administrator specifying which server(s) to reset. In a non-blade system configuration, mechanisms other than the SOAP command could be used to reset the server. This technique may be useful if a server was online and there is a need to use the offline storage configuration process.

The above techniques may provide advantages. For example, a data center may include many blade servers which may use a switch to allocate physical drives to the array controllers. After physical drives are allocated, the user would then use a configuration utility executing on the server to configure logical drives for the array controllers. In large datacenters, this may require that the user create a first set of configuration instructions (scripts) for the switch to configure zoning of physical drives and then a second set of configuration instructions to configure logical drives for those physical drives on each server. The present techniques, in some embodiments, may provide a switch to allow a user to generate a single set of configuration instructions (script) to configure zoning and creation of logical drives on server assigned physical drives. The present techniques may provide the ability to decrease the amount of time it would otherwise take to place datacenters online and a single script for future storage deployment.

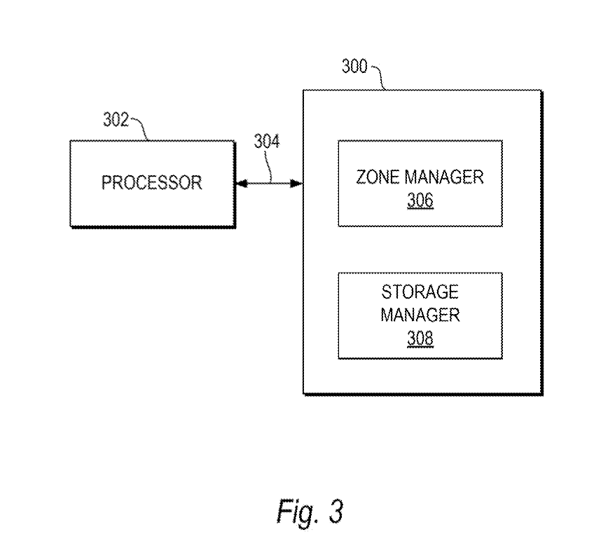

FIG. 3 is a block diagram showing a non-transitory, computer-readable medium that stores code for operating a storage manager in accordance with embodiments. The non-transitory, computer-readable medium is generally referred to by the reference number 300 and may be included in switch 106 of the DAS system 100 described in relation to FIG. 1. The non-transitory, computer-readable medium 300 may correspond to any typical storage device that stores computer-implemented instructions, such as programming code or the like. For example, the non-transitory, computer-readable medium 300 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 302 generally retrieves and executes the instructions stored in the non-transitory, computer-readable medium 300 to operate the storage manager in accordance with embodiments. In an embodiment, the tangible, machine-readable medium 300 can be accessed by the processor 302 over a bus 304. A first region 306 of the non-transitory, computer-readable medium 300 may include zone manager functionality as described herein. A second region 308 of the non-transitory, computer-readable medium 300 may include storage manager functionality as described herein.

Although shown as contiguous blocks, the software components can be stored in any order or configuration. For example, if the non-transitory, computer-readable medium 300 is a hard drive, the software components can be stored in non-contiguous, or even overlapping, sectors.

What is claimed is:

1. A switch comprising:
an expander to couple an array controller to storage drive bays which are capable of supporting physical drives;
a zone manager coupled to the expander to perform zoning configuration of physical drives for the array controller; and
a storage manager to generate storage configuration information to allow the array controller to configure logical drives of the physical drives configured for the array controller.

2. The switch of claim 1, wherein the storage manager is configured to send an inquiry command to the array controller to determine whether the array controller is capable of having the storage manager provide the storage configuration information to allow the array controller to configure logical drives of the physical drives configured for the array controller.

3. The switch of claim 1, wherein the storage manager is configured to send to the array controller the storage configuration information.

4. The switch of claim 1, wherein the storage manager is configured to store at the switch the storage configuration information which is capable of being read by the array controller.

5. The switch of claim 1, wherein the storage manager is configured to send to the array controller a reset command to reset the array controller.

6. The switch of claim 1, wherein the storage manager is configured to receive from the array controller status information regarding status of configuration of logical drives of the physical drives configured for the array controller.

7. A method of using a switch to configure an array controller, the switch having an expander to couple the array controller to storage drive bays capable of supporting physical drives, the method comprising:
performing, by a zone manager of the switch, zoning configuration of physical drives for the array controller; and
generating, by a storage manager of the switch, storage configuration information to allow the array controller to configure logical drives of the physical drives configured for the array controller.

8. The method of claim 7, further comprising sending to the array controller an inquiry command to determine whether the array controller is capable of having the storage manager provide the storage configuration information to allow the array controller to configure logical drives of the physical drives configured for the array controller.

9. The method of claim 7, further comprising sending to the array controller the storage configuration information to allow the array controller to configure logical drives of the physical drives configured to for the array controller.

10. The method of claim 7, further comprising storing the storage configuration information at the switch and allowing the information to be read by the array controller to allow the array controller to configure logical drives of the physical drives configured for the array controller.

11. The method of claim 7, further comprising sending to the array controller a reset command to reset the array controller.

12. The method of claim 7, further comprising receiving from the array controller status information regarding status of configuration of logical drives of the physical drives configured for the array controller.

13. An non-transitory computer computer-readable medium having computer executable instructions stored thereon to use a switch to configure a array controller, the switch having an expander to couple the array controller to storage drive bays which are capable of supporting physical drives, the instruction are executable by a processor to:
perform, by a zone manager of the switch, zoning configuration of physical drives for the array controller; and
generate, by a storage manager at the switch, storage configuration information to allow the array controller to configure logical drives of the physical drives configured for the array controller.

14. The computer readable medium of claim 13 further comprising instructions that if executed cause a processor to:
send to the array controller an inquiry command to determine whether the array controller is capable of having the storage manager provide the storage configuration information to allow the array controller to configure logical drives of the physical drives configured for the array controller.

15. The computer readable medium of claim 13 further comprising instructions that if executed cause a processor to:
send to the array controller the storage configuration information to allow the array controller to configure logical drives of the physical drives configured for the array controller.

16. The computer readable medium of claim 13 further comprising instructions that if executed cause a processor to:
store the storage configuration information at the switch and allow the information to be read by the array controller to allow the array controller to configure logical drives of the physical drives configured for the array controller.

17. The computer readable medium of claim 13 further comprising instructions that if executed cause a processor to:
send to the array controller a reset command to reset the array controller.

18. The computer readable medium of claim 13 further comprising instructions that if executed cause a processor to:
receive from the array controller status information regarding status of configuration of logical drives of the physical drives configured for the array controller.
